(19) United States
(12) Patent Application Publication
(10) Pub. No.: US 2011/0151404 A1
(43) Pub. Date: Jun. 23, 2011

(54) SUCTION ORAL BRUSH

(75) Inventor: Alan R. Dombrowski, Woodbury, MN (US)

(73) Assignee: 3M Innovative Properties Company

(21) Appl. No.: 12/960,799

(22) Filed: Dec. 6, 2010

Related U.S. Application Data
(60) Provisional application No. 61/288,387, filed on Dec. 21, 2009.

(51) Int. Cl. A61C 17/08

(52) U.S. Cl. 433/96

(57) ABSTRACT

A suction oral brush. The oral brush can include a handle having a longitudinal direction and a lumen, and can be adapted to be coupled to a suction source. Bristles can extend outwardly of a first side of a distal end of the handle. A proximal aperture can be formed in the first side of the distal end of the handle that is in fluid communication with the lumen of the handle. The proximal aperture can include a distal end and a proximal end positioned no further distally than a proximal end of the bristles. A distal aperture in fluid communication with the lumen can be formed in a sidewall of the distal end of the handle, and can have a width greater than its height. The bristles can be arranged such that none of the bristles lie on the centerline of the distal end of the handle.

### RELATED APPLICATIONS

Priority is hereby claimed to U.S. Provisional Application Ser. No. 61/288,387, filed Dec. 21, 2009.

### FIELD

The present disclosure generally relates to suction oral brushes, such as toothbrushes, for oral care, and particularly, to low profile suction oral brushes.

### BACKGROUND

Patients who are on a ventilator for more than 48 hours can acquire an infection known as Ventilator Associated Pneumonia (VAP). While patients are on a ventilator, salivary flow can become reduced, which can lead to an accumulation of dental plaque. Dental plaque can become populated with various pathogens that have been known to cause VAP. As a result, it has become a standard practice to provide oral care to a ventilated patient, which can include mechanical plaque removal with an oral brush. When a suction oral brush is employed, oral secretions can also be removed via suctioning while brushing the teeth and oral tissues.

Suction oral brushes can be used to cleanse (i.e., brush and/or suction) teeth, tongues, gums, and/or other oral tissues. Any of the above cleansing or suctioning functions can also be employed during various dental or medical procedures and/or to prepare a patient's mouth for various dental or medical procedures.

### SUMMARY

Some aspects of the present disclosure provide a suction oral brush. The suction oral brush can include a handle. The handle can include a longitudinal direction and a lumen, and can further include a proximal end and a distal end in fluid communication with the proximal end. The proximal end can be adapted to be coupled to a suction source. The suction oral brush can further include a plurality of bristles extending outwardly of a first side of the distal end of the handle. The plurality of bristles can include a proximal end and a distal end. The suction oral brush can further include an aperture formed in the first side of the distal end of the handle, the aperture being in fluid communication with the lumen of the handle. The aperture can include a proximal end and a distal end, and the proximal end of the aperture can be positioned no further distally than the proximal end of the plurality of bristles.

In some aspects of the present disclosure, a suction oral brush is provided. The suction oral brush can include a handle, and the handle can include a longitudinal direction and a lumen. The handle can further include a proximal end and a distal end in fluid communication with the proximal end. The proximal end can be adapted to be coupled to a suction source. The distal end can include a first side and a sidewall. The plurality of bristles can extend outwardly of the first side of the distal end of the handle. The suction oral brush can further include a distal aperture formed in the sidewall of the distal end of the handle. The distal aperture can be in fluid communication with the lumen of the handle. The distal aperture can have a width and a height, and the width can be greater than the height.

Some aspects of the present disclosure provide a suction oral brush. The suction oral brush can include a handle, the handle having a longitudinal direction and a lumen. The handle can include a proximal end and a distal end in fluid communication with the proximal end. The proximal end can be adapted to be coupled to a suction source. The suction oral brush can further include a plurality of bristles extending outwardly of a first side of the distal end of the handle. The plurality of bristles can be arranged such that none of the bristles are positioned along a central longitudinal axis of the distal end of the handle.

Other features and aspects of the present disclosure will become apparent by consideration of the detailed description and accompanying drawings.

### BRIEF DESCRIPTION OF THE DRAWINGS

FIG. 1 is a front perspective view of a suction oral brush according to one embodiment of the present disclosure.

FIG. 2 is a top plan view of the suction oral brush of FIG. 1.

FIG. 3 is a close-up top plan view of the suction oral brush of FIGS. 1 and 2.

FIG. 4 is a close-up bottom plan view of the suction oral brush of FIGS. 1-3.

FIG. 5 is a close-up front elevational view of the suction oral brush of FIGS. 1-4.

FIG. 6 is a close-up side cross-sectional view of the suction oral brush of FIGS. 1-5, taken along line 6-6 of FIG. 3.

FIG. 7 is a close-up rear perspective view of a suction oral brush according to another embodiment of the present disclosure.

FIG. 8 is a close-up front perspective view of the suction oral brush of FIG. 7, with portions removed for clarity.

FIG. 9 is a close-up top plan view of the suction oral brush of FIGS. 7 and 8.

FIG. 10 is a close-up bottom plan view of the suction oral brush of FIGS. 7-9.

FIG. 11 is a close-up front elevational view of the suction oral brush of FIGS. 7-10.

FIG. 12 is a close-up side cross-sectional view of the suction oral brush of FIGS. 7-11, taken along line 12-12 of FIG. 9.

FIG. 13 is a close-up rear perspective view of a suction oral brush according to another embodiment of the present disclosure.

FIG. 14 is a close-up front perspective view of the suction oral brush of FIG. 13, with portions removed for clarity.

FIG. 15 is a close-up top plan view of the suction oral brush of FIGS. 13 and 14.

FIG. 16 is a close-up bottom plan view of the suction oral brush of FIGS. 13-15.

FIG. 17 is a close-up front elevational view of the suction oral brush of FIGS. 13-16.

FIG. 18 is a close-up side cross-sectional view of the suction oral brush of FIGS. 13-17, taken along line 18-18 of FIG. 15.

### DETAILED DESCRIPTION

Before any embodiments of the present disclosure are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the term “coupled” and variations thereof is used broadly and encompasses both direct and indirect couplings. Further, “connected” and “coupled” are not restricted to physical or mechanical connections or couplings. It is to be understood that other embodiments may be utilized, and structural or logical changes may be made without departing from the scope of the present disclosure. Furthermore, terms such as “front,” “rear,” “top,” “bottom,” and the like are only used to describe elements as they relate to one another, but are in no way meant to recite specific orientations of the apparatus, to indicate or imply necessary or required orientations of the apparatus, or to specify how the invention described herein will be used, mounted, displayed, or positioned in use.

The present disclosure generally relates to a suction oral brush that can be used to perform oral care, for example, prior to or during a medical or dental procedure, or on patients who are on a ventilator and need to be inhibited from acquiring infections (such as VAP), for example, while they are treated in intensive care. Particularly, the suction oral brushes of the present disclosure can be used to mechanically remove dental plaque, as well as to cleanse (i.e., brush and/or suction) teeth, tongues, gums, and/or other oral tissues.

Some existing suction oral brushes include a circular distal aperture for suctioning and/or an elongated aperture positioned in a top face of the brush head that is centrally positioned on the head (e.g., with respect to the length and/or width of the brush head), along a middle row of brush bristles. The present inventor, however, recognized that such existing suction oral brushes are typically larger (e.g., in head height and/or width) than regular oral brushes in order to accommodate the suction feature and to provide enough space for the bristles and suction apertures. For example, the recesses that the bristles (or tufts of bristles) are inserted into can be limited to a minimum depth, for example, for adequate bristle retention. In addition, the suction features (e.g., the diameter of the distal aperture and the amount of head material necessary above and below the distal aperture for mechanical strength) can take up horizontal and/or vertical space in the brush head. At least these features (minimum tuft recess depth and suction features) can require that the brush head maintain a minimum width and/or height. In addition, the present inventor recognized that such suction oral brushes generally include shorter bristles than regular oral brushes.

Furthermore, the present inventor identified at least the following potential problems associated with such existing suction oral brush features: (1) the larger brush can make navigating around an endotracheal tube or fitting the brush between the lip and gums much more difficult or invasive to the patient's oral cavity; and/or (2) the shorter bristles can reduce the effectiveness of the brush in cleaning interproximally (i.e., along the tooth and gumline), at least partially because a shorter/stiffer bristle cannot track the gumline as efficiently as a longer/softer bristle.

In addition, the present inventor recognized that simply reducing the size of suction oral brushes could lead to poor mechanical integrity of the brush head, cracking of the tuft recesses during bristle insertion, bristles falling out during use, the brush head cracking around the distal aperture, or combinations thereof.

The suction oral brushes of the present disclosure can include a lower profile (e.g., in width and/or height) to allow for improved access into the oral cavity, for example, around an endotracheal tube, while maintaining bristle and mechanical integrity. In some embodiments, the lower profile oral brush can be obtained by employing a proximal aperture for suctioning. In some embodiments, the lower profile oral brush can be obtained by controlling the geometry and placement of a distal aperture used for suctioning, and/or the geometry and placement of a proximal aperture using for suctioning. In some embodiments, the lower profile can be obtained by controlling the arrangement and number of bristles (or tufts of bristles) and/or by controlling the relative positioning between the bristles and the proximal aperture. Furthermore, in some embodiments, the lower profile can be obtained by employing a lower profile oral brush head, and in such embodiments, longer bristles can be employed, which can improve teeth cleaning performance (e.g., along the gumline), while facilitating access into the oral cavity. In some embodiments, combinations of the above features can be employed.

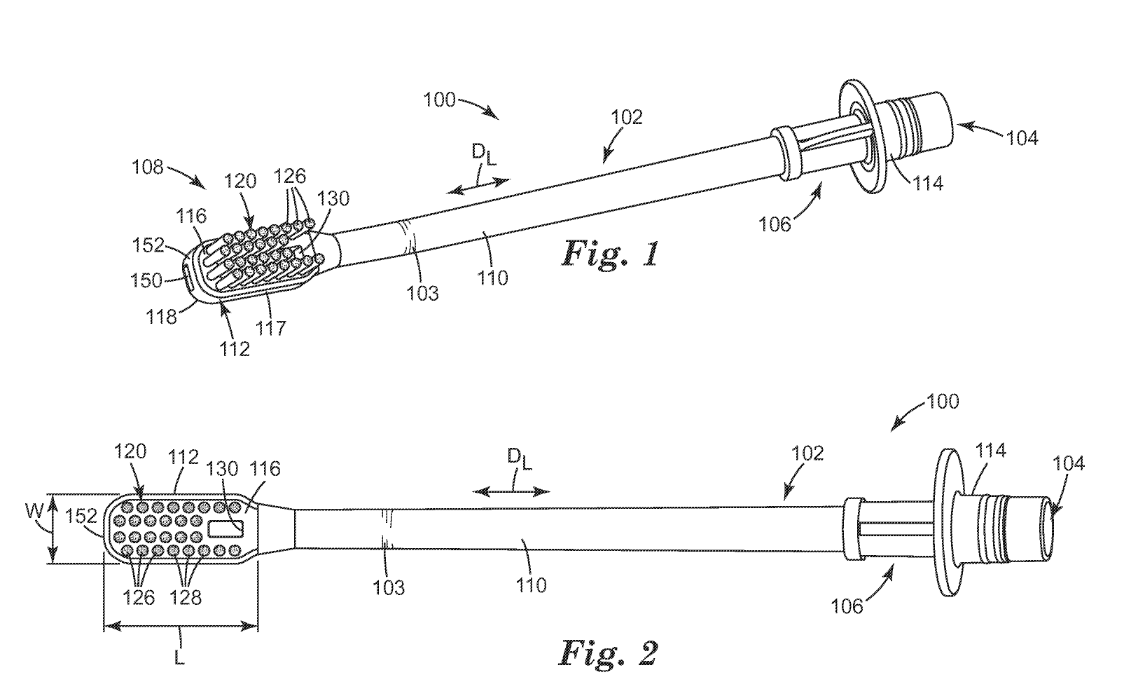

FIGS. 1-6 illustrate a suction oral brush 100 according to one embodiment of the present disclosure. As shown in FIGS. 1-6, the suction oral brush 100 can include a handle 102 having a longitudinal direction D_{L} and a lumen 104 that extends along the longitudinal direction D_{L}. The suction oral brush 100 can further include a proximal end 106 adapted to be coupled to a suction source (not shown) and a distal end 108 in fluid communication with the proximal end 106 (e.g., via the lumen 104). In some embodiments, the handle 102 can include a shaft 110 and a brush head 112 coupled to a distal end of the shaft 110. In some embodiments, the distal end 108 of the suction oral brush 100 can also be the distal end 108 of the handle 102, and can include the head 112.

In some embodiments, the shaft 110 can include a substantially circular cross-sectional shape (e.g., when sectioned substantially perpendicularly to the longitudinal direction D_{L} of the suction oral brush 100), and in some embodiments, the head 112 can include a substantially rectangular, oblong or elongated cross-sectional shape. In some embodiments, the shaft 110 and the head 112 can be integrally formed, and in some embodiments, the shaft 110 and the head 112 can be coupled together. In some embodiments, the definition of where the “head” 112 begins and the “shaft” 102 ends is where the cross-sectional shape of the handle 102 begins to transition from a substantially circular shape to a substantially rectangular, oblong or elongated shape.

In some embodiments, as shown in FIG. 2, the distal end 108 (or the head 112) can include a width W and a length L greater than the width W. In some embodiments, the width W can be no greater than about 0.500 inches (1.3 cm), in some embodiments, no greater than about 0.450 inches (1.1 cm), and in some embodiments, no greater than about 0.400 inches (1.0 cm).

As shown in FIGS. 1 and 2, the proximal end 106 of the suction oral brush 100 can also be the proximal end 106 of the handle 102 and the shaft 110 and can include, or be coupled to, a connector 114 adapted to couple the suction oral brush 100 to a suction source (e.g., a suction handle). The connector 114 can include any suitable couplings or connectors for coupling the suction oral brush 100 to a suction source, and the connector 114 is shown by way of example only.

As shown in FIGS. 1, 2 and 6, the handle 102 can further include a bend 103 positioned to facilitate access to portions of an oral cavity and/or to provide added leverage to the suction oral brush 100 during cleaning or brushing activities. The bend 103 is positioned along the length of the handle 102 as shown by way of example only, and it should be understood that the bend 103 can be positioned differently than that shown, or the handle 102 can include a plurality of bends 103, to provide any desired profile to the handle 102.

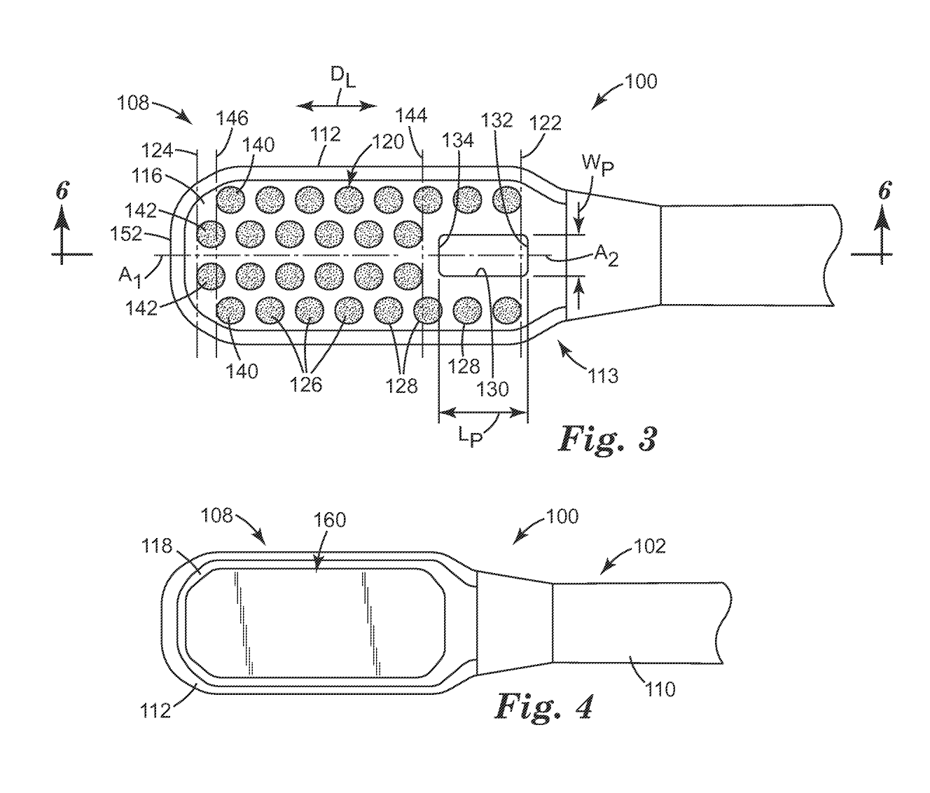

The distal end 108 of the suction oral brush 100 (and particularly, the head 112) can include a first (top) side 116, a sidewall 117, and a second (bottom) side 118 opposite the first side 116. The suction oral brush 100 can further include bristles 120 positioned to extend outwardly (e.g., upwardly) of the first side 116 of the distal end 108 of the handle 102. The bristles 120 can be formed of a variety of suitable materials, such as nylon. As shown in FIG. 3, the bristles 120 as a whole can include a proximal end 122 and a distal end 124. As further shown, the bristles 120 can be arranged into one or more bundles or tufts 126. Each tuft 126 of bristles 120 can be dimensioned to be received in a recess or aperture 128 formed in the first side 116 of the distal end 108 of the handle 102.

As described in greater detail below, in some embodiments, the bristles 120 can be arranged in a number of tufts 126, for example, ranging from twenty-six tufts 126 to thirty tufts 126, and in some embodiments, twenty-eight tufts 126.

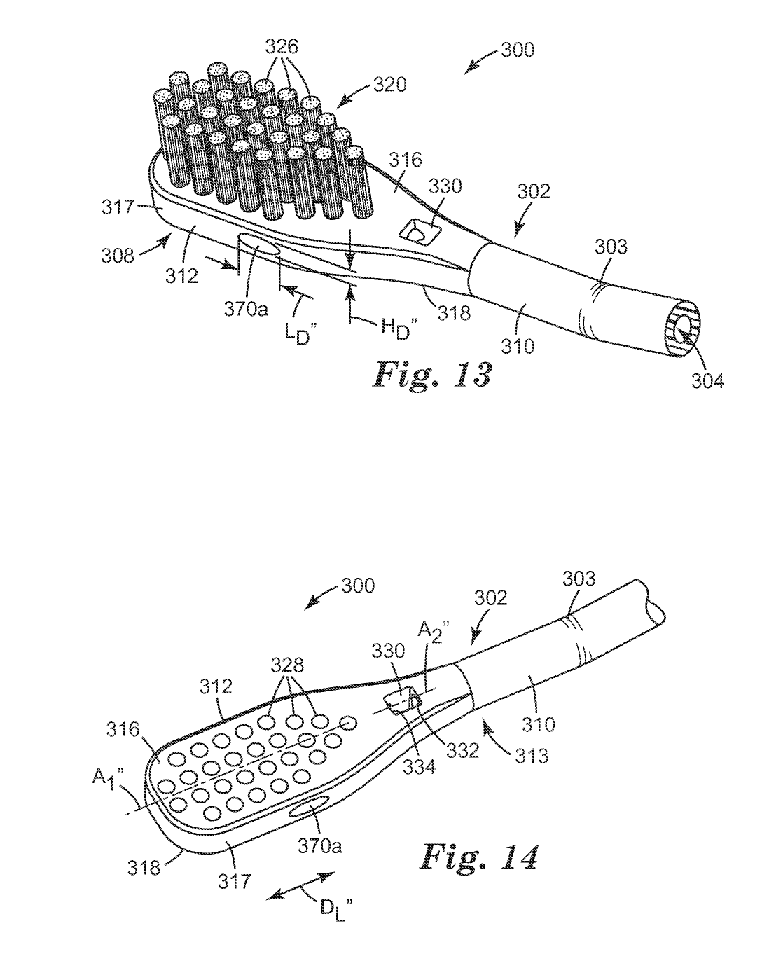

As shown in FIGS. 1-3 and 6, the suction oral brush 100 can further include an aperture 130 (sometimes referred to as a “proximal aperture”) formed in the first side 116 of the distal end 108 of the handle 102, or particularly, in the first side 116 of the head 112, but not the second side 118. However, it should be understood that in some embodiments, as shown in FIGS. 13-18 and described below, the aperture 130 can be formed through the second side 118 instead of, or in addition to, being formed through the first side 116. In such embodiments, this can be referred to as two proximal apertures 130—one formed through the first side 116 and one formed through the second side 118.

As shown in FIG. 6, the aperture 130 can be positioned in fluid communication with the lumen 104 of the handle 102. As a result, the aperture 130 can be positioned to fluidly couple ambience to the lumen 104 (and to a suction source to which the suction oral brush 100 is coupled) and can be used as a suction hole. In some embodiments, the suction oral brush 100 can include a first lumen (or a first portion of the lumen 104) that is positioned in the shaft 110 and a second lumen (or a second portion of the lumen 104) that is positioned in the head 112 that is in fluid communication with the first lumen. For simplicity, however, the handle 102 will be described as having a lumen 104 that extends in the head 112 and the shaft 110, generally along the longitudinal direction D_{L}.

As shown in FIGS. 3 and 6, the aperture 130 can be positioned toward a proximal end 113 of the head 112, and the aperture 130 can include a proximal end 132 and a distal end 134. As further shown in FIGS. 3 and 6, in some embodiments, the proximal end 132 of the aperture 130 can be positioned no further distally than the proximal end 122 of the bristles 120. In the embodiment illustrated in FIGS. 1-6, the proximal end 132 of the aperture 130 is positioned proximally with respect to the proximal end 122 of the bristles 120.

As shown in FIG. 3, the aperture 130 can include a width W_{P} and a length L_{P} that is greater than the width W_{P}, such that the aperture 130 is elongated (e.g., rectangular, elliptical, oblong, etc.) and extends along the longitudinal direction D_{L}. Furthermore, the aperture 130 can be positioned along a central longitudinal axis A₁ of the suction oral brush 100 and the handle 102, such that a central longitudinal axis A₂ of the aperture 130 is substantially in line with the central longitudinal axis A₁, and such that the aperture 130 is centrally positioned with respect to the head 112, and particularly, with respect to the width W of the head 112 (and with respect to a width of the first side 116 of the distal end 108 of the handle 102). As shown in FIGS. 2 and 3, in some embodiments, none of the bristles 120 are positioned along the central longitudinal axis A₁ of the suction oral brush 100 or “centerline” of the head 112.

In some embodiments, the width W_{P} of the aperture 130 can be at least about 0.1 inches (0.25 cm), in some embodiments, at least about 0.12 inches (0.3 cm), and in some embodiments, at least about 0.15 inches (0.4 cm). In some embodiments, the width W_{P} of the aperture 130 can be no greater than about 0.2 inches (0.5 cm), and in some embodiments, no greater than about 0.18 inches (0.45 cm).

In some embodiments, the length L_{P} of the aperture 130 can be can be at least about 0.1 inches (0.25 cm), in some embodiments, at least about 0.15 inches (0.4 cm), and in some embodiments, at least about 0.2 inches (0.5 cm). In some embodiments, the length L_{P} of the aperture 130 can be no greater than about 0.3 inches (0.8 cm), and in some embodiments, no greater than about 0.25 inches (0.6 cm).

In some embodiments, the ratio of the width W_{P} of the aperture 130 to the width W of the distal end 108 of the handle 102 (or the head 112) can be at least about 0.2, in some embodiments, at least about 0.25, and in some embodiments, at least about 0.3. In some embodiments, the ratio of the width W_{P} of the aperture 130 to the width W of the distal end 108 of the handle 102 (or the head 112) can be no greater than about 0.5, in some embodiments, no greater than about 0.45, and in some embodiments, no greater than about 0.4.

In some embodiments, the ratio of the length L_{P} of the aperture 130 to the length L of the distal end 108 of the handle 102 (or the head 112) can be no greater than about 0.25, in some embodiments, no greater than about 0.15, and in some embodiments, no greater than about 0.10.

The bristles 120, and particularly, the arrangement of the bristles 120 will now be described in greater detail with reference to FIG. 3. As shown in FIG. 3, in the embodiment illustrated in FIGS. 1-6, the suction oral brush 100 includes twenty-eight tufts 126 of bristles 120 (and recesses 128 dimensioned to receive the tufts 126) arranged in four longitudinal rows—two outer longitudinal rows 140 of tufts 126 positioned adjacent an outer edge or wall (e.g., the sidewall 117) of the head 112, and two inner longitudinal rows 142 of tufts 126 positioned adjacent, but not on, the central longitudinal axis A₁ of the handle 102. The rows 140, 142 can be arranged so as to maximize the density of the bristles 120 (or of the tufts 126) on the first side 116 of the head 112. Four longitudinal rows 140, 142 are shown by way of example only, but it should be understood that other numbers of rows can be employed, such as six longitudinal rows.

Each of the two outer rows 140 of tufts 126 is shown as including 8 tufts, and at least a portion of each outer row 140 (e.g., the portion of the bristles 120 that forms the proximal end 122) is positioned adjacent the length L_{P} of the proximal aperture 130 on the first side 116 of the head 112. Said another way, the outer rows 140 can extend further proximally than the inner rows 142 and can provide the overall proximal end 122 of the bristles 120, such that the proximal end 132 of the aperture 130 is positioned no further distally than the proximal end 122 of the outer rows 140. Each of the two inner rows 142 of tufts 126 is shown as including 6 tufts (and is thus shorter than either of the outer rows 140, i.e., the outer rows 140 are longer and extend further along the longitudinal direction D_{L} than the inner rows 142). Furthermore, a proximal end 144 of each inner row 142 is positioned adjacent the width W_{P} and the distal end 134 of the aperture 130. In some embodiments, as further shown in FIG. 3, the inner rows 142 can be positioned distally with respect to the aperture 130, and particularly, the proximal end 144 of the inner rows 142 can be positioned distally with respect to the distal end 134 of the aperture 130.

As shown in FIG. 3, in some embodiments, the longitudinal rows 140, 142 of tufts 126 can be uniformly spaced across the width W of the head 112, can be centered with respect to the width W of the head 112, and/or can be arranged symmetrically with respect to the central longitudinal axis A₁ of the handle 102 and/or the central longitudinal axis A₂ of the proximal aperture 130. In addition, as shown in FIG. 3, in some embodiments, the outer rows 140 (or at least a distal end 146 of the outer rows 140) can be offset a distance along the longitudinal direction D_{L} (e.g., along the length L of the head 112) from the inner rows 142. That is, in some embodiments, the inner rows 142 can extend further distally than the outer rows 140, and can form the overall distal end 124 of the bristles 120.

With continued reference to FIG. 3, in some embodiments, at least partially due to the arrangement of the rows 140, 142 of tufts 126 and the spacing between the rows 140, 142, the width W_{P} of the aperture 130 can at the size of an overall width of two rows 140, 142 (e.g., the two inner rows 142) of tufts 126, where the “overall width” of two rows 140, 142 of tufts 126 includes the width (or diameter) of two tufts 126 (or two rows 140, 142) and the spacing between the two rows 140, 142. In some embodiments, the width W_{P} of the aperture 130 can be equal to the center-to-center distance between two rows 140, 142 (or between adjacent tufts 126). Furthermore, in some embodiments, the width W_{P} of the aperture 130 can be greater than the spacing between two adjacent rows 140, 142 of bristles 120 (or tufts 126 of bristles 120).

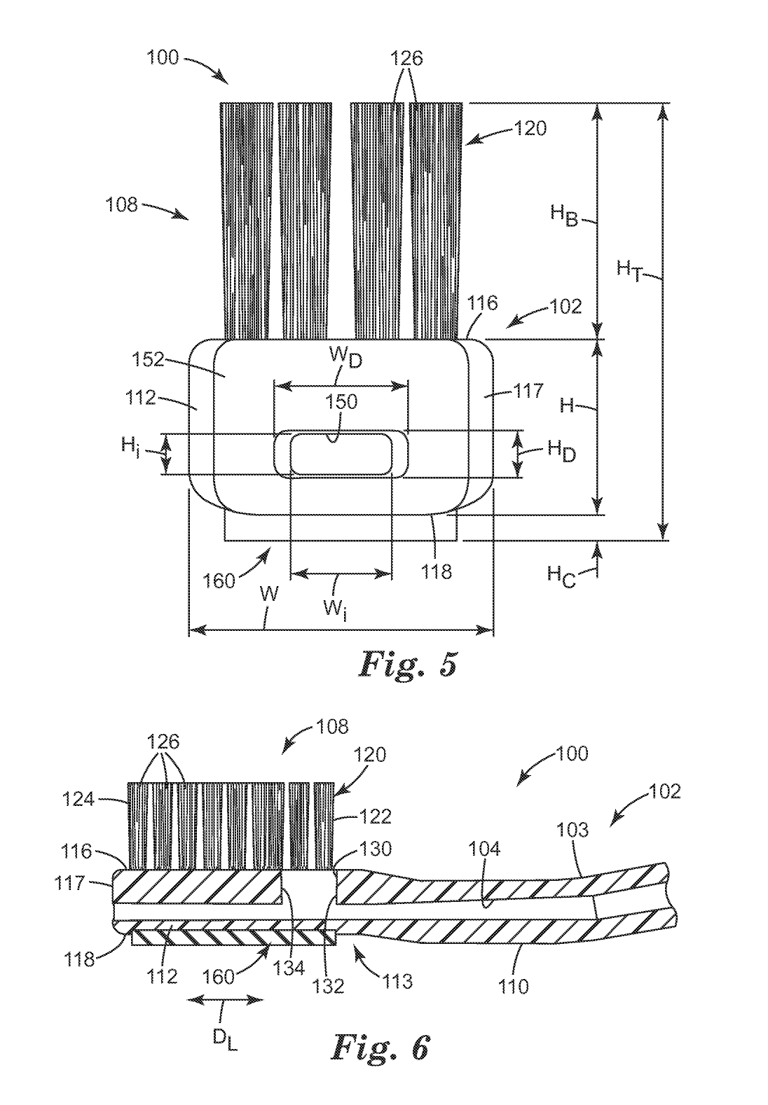

As mentioned above, the bristles 120 can be suitably long and flexible, particularly, relative to the head 112, to facilitate effectively cleaning the teeth and gums. With reference to FIG. 5, in some embodiments, the bristles 120 can be formed to a substantially uniform height H_{B}. In some embodiments, the height H_{B} can be at least about 0.3 inches (0.8 cm), and in some embodiments, at least about 0.33 inches (0.84 cm), and in some embodiments, can be at least about 0.35 inches (0.9 cm). Such bristle heights can facilitate the removal of dental plaque from a patient's mouth, which can reduce the likelihood that the patient will acquire VAP.

In some embodiments, as further shown in FIG. 5, the head 112 can have a substantially uniform height H, for example, such that the first side 116 from which the bristles 120 extend is substantially flat. In some embodiments, the height H can be at least about 0.2 inches (0.5 cm), and in some embodiments, at least about 0.24 inches (0.6 cm). In some embodiments, the height H can be no greater than about 0.32 inches (0.81 cm), in some embodiments, no greater than about 0.3 inches (0.8 cm), in some embodiments, no greater than about 0.28 inches (0.7 cm), and in some embodiments, no greater than 0.2 inches (0.5 cm). In some embodiments, the height H is about 0.26 inches (0.66 cm).

In some embodiments, the distal end 108 of the suction oral brush 100 can include an overall or total height H_{T}, which can include the bristle height H_{B} and the head height H, as well as the height of a cleaning pad, if employed, as described below. In embodiments in which a cleaning pad is not employed, the total height H_{T} can be equal to the sum of the bristle height H_{B} and the head height H. In some embodiments, the total height H_{T} can be no greater than about 0.87 inches (2.2 cm), in some embodiments, no greater than about 0.65 inches (1.7 cm), and in some embodiments, no greater than about 0.57 inches (1.4 cm).

Furthermore, in some embodiments, the ratio of the bristle height H_{B} to the total height H_{T} can be at least about 0.35, in some embodiments, at least about 0.4, in some embodiments, at least about 0.5, and in some embodiments, at least about 0.6. In some embodiments, the ratio of the head height H to the total height H_{T} can be no greater than about 0.6, in some embodiments, no greater than about 0.5, and in some embodiments, no greater than about 0.3.

In some embodiments, the bristles 120 do not have a uniform overall height across the head 112. In some embodiments, the bristles 120 can include a shaped profile, such as a so-called “powerpoint” profile known in the field of toothbrushes where the distal bristles 120 have a noticeably greater height than the other bristles 120, for example, to facilitate interproximal cleaning In such embodiments, the bristle height H_{B} can refer to the minimum bristle height. In addition, in some embodiments, the bristles 120 positioned away from the central longitudinal axis A₁ (e.g., in the outer longitudinal rows 140) can be longer (i.e., have a greater height H_{B}) than the bristles 120 positioned toward the central longitudinal axis A₁ (e.g., in the inner longitudinal rows 142), or vice versa. In such embodiments, the bristle height H_{B} can refer to the maximum bristle height H_{B}, and the total height H_{T} of the distal end 108 can refer to the maximum total height H_{T} of the distal end 108.

The relative positioning and arrangement between the bristles 120 and the aperture 130 described above can allow the head 112 (or the distal end 108 of the handle 102) to have a suitable (e.g., reduced) width W, e.g., to facilitate accessing an oral cavity, and can allow the bristles 120 a relatively dense configuration, e.g., to facilitate cleaning a patient's teeth and gums.

Furthermore, as shown in FIGS. 1, 5 and 6, in some embodiments, the suction oral brush 100 can further include an aperture 150 (sometimes referred to as a “distal aperture”) formed in the sidewall 117 of the distal end 108 of the handle 102, and positioned in fluid communication with the lumen 104. However, it should be understood that the “distal aperture” need not be positioned distally with respect to the “proximal” aperture and these terms are used by way of example only. In some embodiments, the aperture 130 can instead be referred to as a “surface” aperture 130, and the aperture 150 can be referred to as an “end” aperture or a “sidewall” aperture. In the embodiment illustrated in FIGS. 1-6, the distal aperture 150 is formed in a distal tip 152 of the head 112. The distal aperture 150 can provide access to the lumen 104, such that the distal aperture 150 fluidly couples ambience to the lumen 104 (and to a suction source to which the suction oral brush 100 is coupled), and can be used for suctioning.

As shown in FIG. 5, the distal aperture 150 can include a width W_{D} and a height H_{D}, and the width W_{D} can be greater than the height H_{D}. The distal aperture 150 can be elongated (e.g., rectangular, elliptical, oblong, etc.) and oriented in a direction substantially orthogonal to the longitudinal direction D_{L}. Said another way, the distal aperture 150 can be elongated along the width W of the head 112. Such a configuration of the distal aperture 150 can allow the head 112 (or the distal end 108 of the handle 102) to have a suitable (e.g., reduced) height, which can facilitate accessing and navigating an oral cavity, while maintaining or improving the cross-sectional area for suctioning.

As further shown in FIG. 5, in some embodiments, the distal aperture 150 can taper in width and/or height, for example, inwardly toward the lumen 104. In such embodiments, the width W_{D} and the height H_{D} can be an outer width and an outer height, respectively, and the distal aperture 150 can further include an inner width W, and an inner height Hᵢ. The inner width Wᵢ can be greater than the inner height Hᵢ.

In some embodiments, the width W_{D} (or the inner width Wᵢ) of the distal aperture 150 can be at least about 0.1 inches (0.25 cm), in some embodiments, at least about 0.12 inches (0.3 cm), and in some embodiments, at least about 0.15 inches (0.4 cm). In some embodiments, the width W_{D} of the aperture 150 can be no greater than about 0.2 inches (0.5 cm), and in some embodiments, no greater than about 0.18 inches (0.45 cm).

In some embodiments, the height H_{D} (or the inner height Hᵢ) of the distal aperture 150 can be can be at least about no greater than about 0.075 inches (0.2 cm), and in some embodiments, no greater than about 0.05 inches (0.13 cm).

In some embodiments, the cross-sectional area of the aperture 150 can be at least about 0.005 inches² (0.03 cm²), in some embodiments, at least about 0.006 inches² (0.04 cm²), and in some embodiments, at least about 0.0075 inches (0.05 cm²). In some embodiments, the cross-sectional area of the aperture 150 can be no greater than about 0.015 inches² (0.1 cm²), in some embodiments, no greater than about 0.0135 inches² (0.09 cm²), and in some embodiments, no greater than about 0.01 inches² (0.07 cm²).

In some embodiments, the width W_{D} (or the inner width Wᵢ) can be greater than the height H_{D} (or the inner height Hᵢ) by at least about 0.025 inches (0.06 cm), in some embodiments, by at least about 0.05 inches (0.13 cm), in some embodiments, by at least about 0.075 inches (0.2 cm), and in some embodiments, by at least about 0.125 inches (0.318 cm).

In some embodiments, the ratio of the width W_{D} (or the inner width W) of the distal aperture 150 to the width W of the distal end 108 of the handle 102 (or the head 112) can be at least about 0.3, in some embodiments, at least about 0.4, and in some embodiments, at least about 0.45.

In some embodiments, the width W_{P} of the proximal aperture 130 can be as wide as the width W_{D} of the distal aperture 150. As a result, similar ratios or relationships between the width W_{P} of the proximal aperture 130 and other features of the suction oral brush 100, such as the width W of the distal end 108 of the handle 102 (or the head 112), can be the same as those of the width W_{D} of the distal aperture 150.

In some cases, the tuft recesses 128 can have a depth of at least about 0.160 inches (0.4 cm), for example, for adequate tuft retention after insertion of the tuft 126 into the recess 128. Because the distal aperture 150 (and the lumen 104) runs along the length L of the head 112, the height H_{P} of the distal aperture 150 (and the lumen 104) can take up vertical space within the head 112. In addition, adequate material above and below the distal aperture 150 (and the lumen 104) can achieve a suitable mechanical strength of the head 112, for example, so that the tuft recesses 128 do not crack when the tufts 126 are inserted into them. As a result, the depth of the tuft recesses 128, the height Hp of the distal aperture 150 (and the lumen 104), and/or the height of the head 112 above and below the distal aperture 150 (and the lumen 104) can be considered in designing the height H of the head 112.

As shown in FIGS. 4-6, in some embodiments, the suction oral brush 100 can further include a cleaning pad 160. In some embodiments, as shown in FIGS. 4-6, the cleaning pad 160 can be coupled to the second side 118 of the head 112. As a result, in some embodiments, the suction oral brush 100 can be used in one orientation to clean teeth and gums and can be flipped over to clean the tongue or other oral tissues. In some embodiments, the cleaning pad 160 can be formed of a foam material (e.g., a polyurethane foam) that can be coupled to the second side 118 of the head 112. In some embodiments, as shown in FIGS. 4-6, the cleaning pad 160 can be formed of a thermoplastic elastomer (TPE), such as styrene-ethylene/butylene-styrene (SEBS) that can be overmolded, for example, onto the second side 118 of the head 112. In such embodiments, the cleaning pad 160 can include one or more projections, which can be configured in a variety of patterns, to facilitate cleaning of the tongue or other oral tissues.

As shown in FIG. 5, the cleaning pad 160 can include a height H_{C} that, in some embodiments, can be at least about 0.03 inches (0.08 cm), in some embodiments, at least about 0.05 inches (0.13 cm), and in some embodiments, at least about 0.08 inches (0.2 cm). In some embodiments, the height H_{C} of the cleaning pad 160 can be no greater than about 0.2 inches (0.5 cm), in some embodiments, no greater than about 0.15 inches (0.4 cm), and in some embodiments, no greater than about 0.1 inches (0.25 cm).

In some embodiments, the ratio of the height H_{C} of the cleaning pad 160 to the total height H_{T} of the distal end 108 can be no greater than about 0.35, in some embodiments, no greater than about 0.2, in some embodiments, no greater than about 0.1, in some embodiments, no greater than about 0.05, and in some embodiments, no greater than about 0.03.

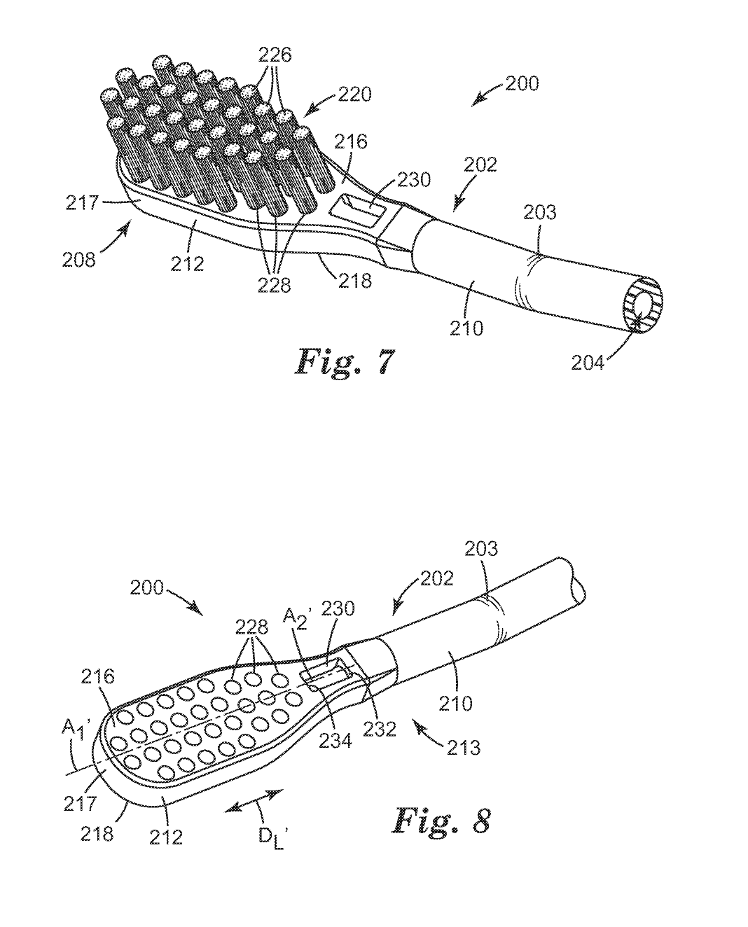

FIGS. 7-12 illustrate another suction oral brush 200 according to the present disclosure, wherein like numerals represent like elements. The suction oral brush 200 shares many of the same elements and features described above with reference to the illustrated embodiment of FIGS. 1-6. Accordingly, elements and features corresponding to elements and features in the illustrated embodiment of FIGS. 1-6 are provided with the same reference numerals in the 200 series. Reference is made to the description above accompanying FIGS. 1-6 for a more complete description of the features and elements (and alternatives to such features and elements) of the embodiment illustrated in FIGS. 7-12.

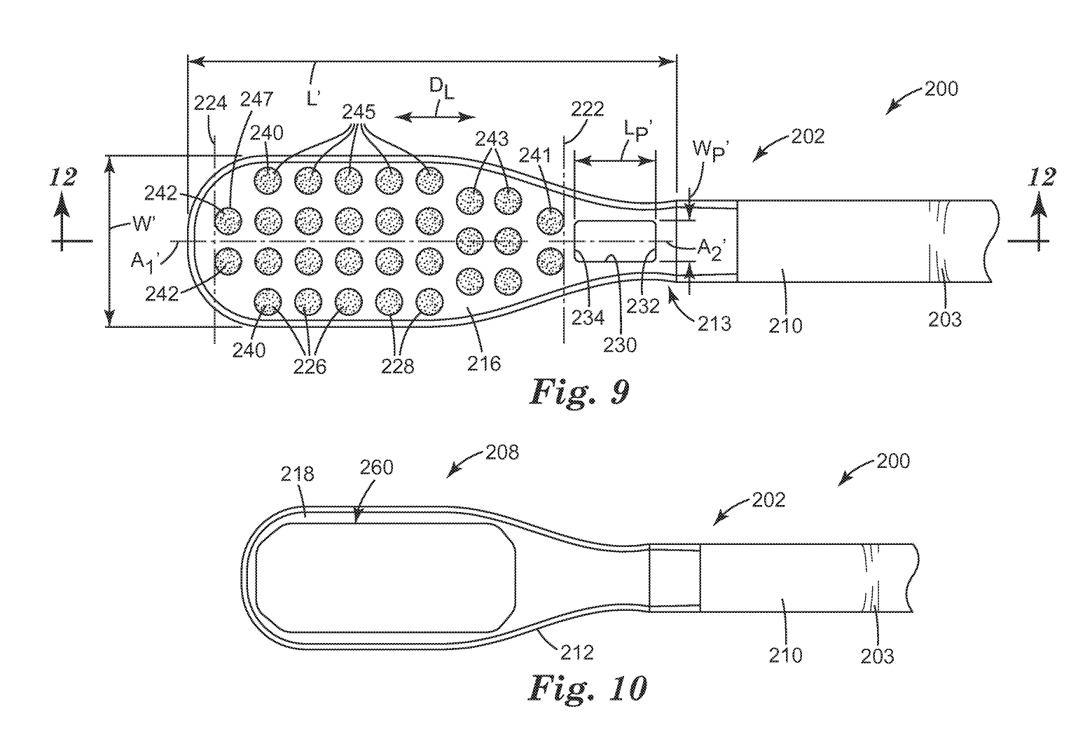

The suction oral brush 200 can include a handle 202 having a longitudinal direction D_{L}′ and a lumen 204 that extends along the longitudinal direction D_{L}′. The suction oral brush 200 can further include a proximal end (not shown) adapted to be coupled to a suction source (not shown) and a distal end 208 in fluid communication with the proximal end. In some embodiments, the handle 202 can include a shaft 210 and a brush head 212 coupled to a distal end of the shaft 210. In some embodiments, the distal end 208 of the suction oral brush 200 can also be the distal end 208 of the handle 202, and can include the head 212. In some embodiments, as shown in FIG. 9, the distal end 208 (or the head 212) can include a width W′ and a length L′ greater than the width W′.

As shown in FIGS. 7-10 and 12, the handle 202 can further include a bend 203 positioned along its length. The distal end 208 of the suction oral brush 200 (and particularly, the head 212) can include a first (top) side 216, a sidewall 217, and a second (bottom) side 218 opposite the first side 216. The suction oral brush 200 can further include bristles 220 (removed from FIG. 8 for clarity) positioned to extend outwardly (e.g., upwardly) of the first side 216 of the distal end 208 of the handle 202. As shown in FIGS. 9 and 12, the bristles 220 as a whole can include a proximal end 222 and a distal end 224. As further shown, the bristles 220 can be arranged into one or more bundles or tufts 226. Each tuft 226 of bristles 220 can be dimensioned to be received in a recess or aperture 228 formed in the first side 216 of the distal end 208 of the handle 202.

As shown in FIGS. 7-9 and 12, the suction oral brush 200 can further include an aperture 230 (sometimes referred to as a “proximal aperture”) formed in the first side 216 of the distal end 208 of the handle 202, or particularly, in the first side 216 of the head 212.

As shown in FIG. 12, the aperture 230 can be positioned in fluid communication with the lumen 204 of the handle 202. As a result, the aperture 230 can be positioned to fluidly couple ambience to the lumen 204 (and to a suction source to which the suction oral brush 200 is coupled) and can be used as a suction hole. In the embodiment illustrated in FIGS. 7-12, the aperture 230 is formed in the first side 216 of the head 212 but not in the second side 218; however, it should be understood that in some embodiments, the aperture 230 can also be formed through the second side 218. In addition, in the embodiment illustrated in FIGS. 7-12, the lumen 204 extends along the longitudinal direction D_{L}′ through the handle 202 and to the aperture 230, but does not extend further distally than the aperture 230. Furthermore, the suction oral brush 200 does not include a distal aperture and suctioning is provided by the proximal aperture 230 alone. Such a configuration can allow for a shorter (or thinner) head 212, as will be described in greater detail below.

As shown in FIGS. 8, 9 and 12, the aperture 230 can be positioned toward a proximal end 213 of the head 212, and the aperture 230 can include a proximal end 232 and a distal end 234. As further shown in FIGS. 8, 9 and 12, the aperture 230 can be positioned entirely proximally of the bristles 220, such that the proximal end 232 of the aperture 230 can be positioned no further distally than the proximal end 222 of the bristles 220. In addition, the distal end 234 of the aperture 230 can be positioned no further distally than the proximal end 222 of the bristles 220. In the embodiment illustrated in FIGS. 7-12, the proximal end 232 and the distal end 234 of the aperture 230 are positioned proximally with respect to the proximal end 222 of the bristles 220. Such a configuration of the aperture 230 and relative positioning of the aperture 230 and the bristles 220 can provide for a suitable (e.g., reduced) width W′ of the head 212.

As shown in FIG. 9, the aperture 230 can include a width W_{P}′ and a length L_{P}′ that is greater than the width W_{P}′, such that the aperture 230 is elongated (e.g., rectangular, elliptical, oblong, etc.) and extends along the longitudinal direction D_{L}′. Furthermore, the aperture 230 can be positioned along a central longitudinal axis A₁′ of the suction oral brush 200 and the handle 202, such that a central longitudinal axis A₂′ of the aperture 230 is substantially in line with the central longitudinal axis A₁′, and such that the aperture 230 is centrally positioned with respect to the head 212, and particularly, with respect to the width W′ of the head 212 (and with respect to a width of the first side 216 of the distal end 208 of the handle 202). As shown in FIGS. 8 and 9, in some embodiments, two of the tufts 226 of bristles 220 (and the recesses 228 in which the tufts 226 are received) can be positioned along the central longitudinal axis A₁′ of the suction oral brush 200.

The range of values of the width W′ of the head 212 and the dimensions and relative dimensions of the aperture 230 can be the same as those of the head 112 and aperture 130, described above and shown in FIGS. 1-6.

The bristles 220, and particularly, the arrangement of the bristles 220 will now be described in greater detail with reference to FIG. 9. As shown in FIG. 9, in the embodiment illustrated in FIGS. 7-12, the suction oral brush 200 includes 30 tufts 226 (and recesses 228 dimensioned to receive the tufts 226) of bristles 220 arranged in nine transverse rows oriented substantially perpendicularly with respect to the longitudinal direction D_{L}′. Moving distally along the head 212, as shown in FIG. 9, the nine transverse rows can be formed of: a first row 241 of two tufts 226; followed by two second rows 243 of three tufts 226, the center tuft 226 of each second row 243 falling along the central longitudinal axis A₁′ of the handle 202 and/or the central longitudinal axis A₂′ of the aperture 230; followed by five third rows 245 of four tufts 226; followed by a final fourth row 247 of two tufts 226. Said another way, the bristles 220 can be arranged into four groups of tufts 226—a first group comprising one transverse row 241 of two tufts 226; a second group comprising two transverse rows 243, each row 243 comprising three tufts 226 for a total of six tufts 226; a third group comprising five transverse rows 245, each row 245 comprising four tufts 226 for a total of twenty tufts 226; and a fourth group comprising one transverse row 247 of two tufts 226.

As shown in FIGS. 7-9, each transverse row 241, 243, 245, 247 can be centered with respect to the width W′ of the head 212, can be centered over the central longitudinal axis A₁′ of the handle 202 and/or the central longitudinal axis A₂ of the aperture 230, and/or can be symmetrical about the central longitudinal axis A₁′ of the handle 202 and/or the central longitudinal axis A₂′ of the aperture 230. As further shown in FIG. 9, in some embodiments, the tufts 226 can be substantially uniformly spaced across the width W′ and the length L′ of the head 212. Furthermore, only the center two tufts 226 of the second transverse rows 243 fall on the centerline of the head 212, i.e., along the central longitudinal axis A₁′ of the handle 202 and/or the central longitudinal axis A₂′ of the aperture 230.

In addition, the width W′ of the head 212 can vary along its length L′, such that each transverse row 241, 243, 245, 247 includes one or more tufts 226 that are positioned adjacent an outer edge or wall (e.g., the sidewall 217) of the head 212. As a result of the above configurations, in some embodiments, the suction oral brush 200 can include thirty tufts 226 of bristles 220, and the density of the bristles 220 (or the tufts 226) can be maximized on the first side 216 of the head 212. Similar to the suction oral brush 100, at the widest portion of the head 212, the suction oral brush 200 includes four longitudinal rows—two outer longitudinal rows 240 and two inner longitudinal rows 242. However, in some embodiments, at least a portion of the head 112 of the suction oral brush 100 or the head 212 of the suction oral brush 200 can include six longitudinal rows.

Furthermore, as shown in FIGS. 7-9, the first transverse row 241 can be positioned adjacent the width W_{P}′ of the aperture 230, such that the proximal end 222 of the bristles 220 is positioned adjacent the width W_{P}′ and the distal end 234 of the aperture 230. In addition, in some embodiments, the width W_{P}′ of the aperture 230 can be less than an overall width of the first or fourth transverse row 241 or 247 (or of two tufts 226), where the “overall width” of the first or fourth transverse row 241 or 247 (or two tufts 226) includes the width (or diameter) of two tufts 226 and the spacing between the two tufts 226.

The relative positioning and arrangement between the bristles 220 and the aperture 230 described above can allow the head 212 (or the distal end 208 of the handle 202) to have a suitable (e.g., reduced) width W′, e.g., to facilitate accessing an oral cavity, and can allow the bristles 220 a relatively dense configuration, e.g., to facilitate cleaning a patient's teeth and gums.

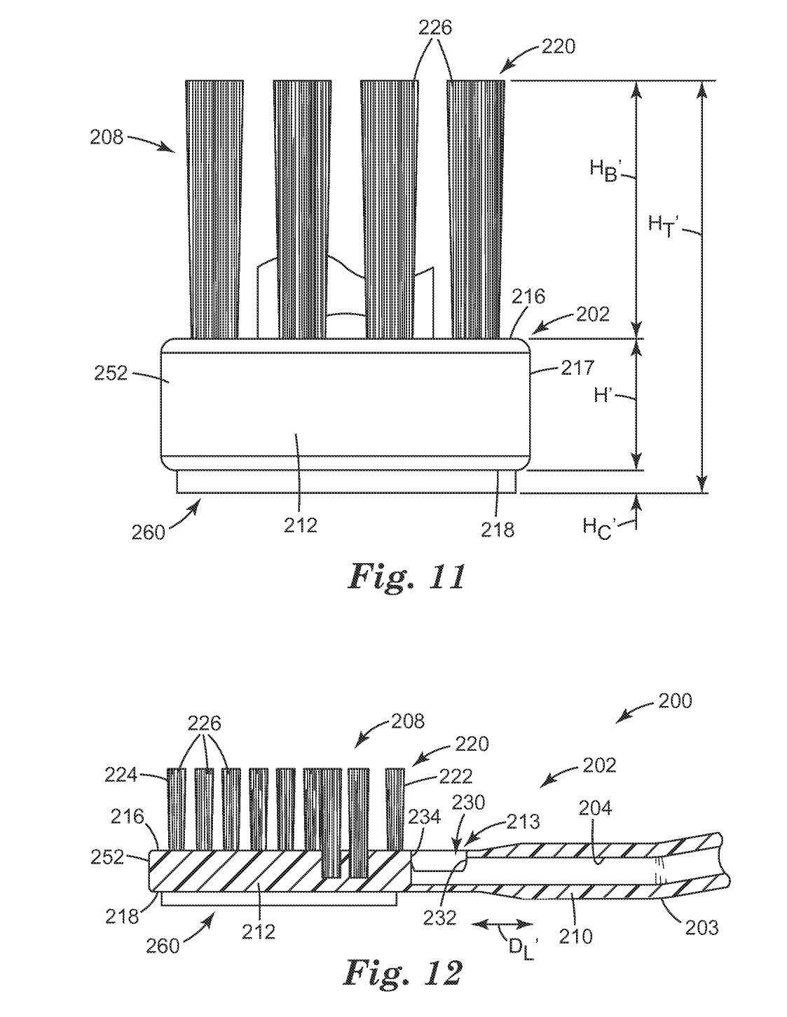

With reference to FIG. 11, in some embodiments, the bristles 220 can be formed to a substantially uniform height H_{B}′, the head 212 can have a substantially uniform height H′ (i.e., the first side 216 can be substantially flat), and distal end 208 of the suction oral brush 200 can have a total height H_{T}′, which can include the bristle height H_{B}′ and the head height H′, as well as the height of a cleaning pad, if employed, as described below. The range of values of the bristle height H_{B}′, the head height H′, the total height H_{T}′, and the relative values and ratios thereof, can be same as those of the bristle height H_{B}, head height H, and total height H_{T} described above and shown in FIGS. 1-6, except that the head height H′ and the total height H_{T}: can be less than that of the embodiment of FIGS. 1-6.

As shown in FIGS. 11 and 12 and mentioned above, in some embodiments, the suction oral brush 200 does not include a distal aperture such that a distal tip 252 of the head 212 is closed and is not in fluid communication with the lumen 204 or a suction source. Not including a distal aperture in the suction oral brush 200 can allow the head height H′ and the total height H_{T}′ to be substantially reduced.

For example, in some embodiments, the head height H′ of the head 212 can be no greater than about 0.2 inches (0.5 cm), in some embodiments, no greater than about 0.175 inches (0.45 cm), and in some embodiments, no greater than about 0.15 inches (0.4 cm). Furthermore, in some embodiments, the total height H_{T}′ can be no greater than about 0.6 inches (1.5 cm), in some embodiments, no greater than about 0.5 inches (1.3 cm), and in some embodiments, no greater than about 0.45 inches (1.1 cm).

As shown in FIGS. 10-12, in some embodiments, the suction oral brush 200 can further include a cleaning pad 260. In some embodiments, as shown in FIGS. 10-12, the cleaning pad 260 can be coupled to the second side 218 of the head 212. The cleaning pad 260 can be formed of the same materials as the cleaning pad 160 of FIGS. 1-6 and can include one or more projections configured to facilitate cleaning of the tongue or other tissues.

As shown in FIG. 11, the cleaning pad 260 can include a height H_{C}′, which can be included in the total height H_{T}′ of the distal end 208 of the suction oral brush 200. In addition, the values of the cleaning pad height H_{C}′ and its relationships to the head height H′ and the total height H_{T}′ can be the same as the cleaning pad height H_{C}, the head height H, and the total height H_{T} of FIGS. 1-6, described above.

FIGS. 13-18 illustrate another suction oral brush 300 according to the present disclosure, wherein like numerals represent like elements. The suction oral brush 300 shares many of the same elements and features described above with reference to the illustrated embodiments of FIGS. 1-6 and 7-12. Accordingly, elements and features corresponding to elements and features in the illustrated embodiments of FIGS. 1-6 and 7-12 are provided with the same reference numerals in the 300 series. Reference is made to the description above accompanying FIGS. 1-6 and 7-12 for a more complete description of the features and elements (and alternatives to such features and elements) of the embodiment illustrated in FIGS. 13-18.

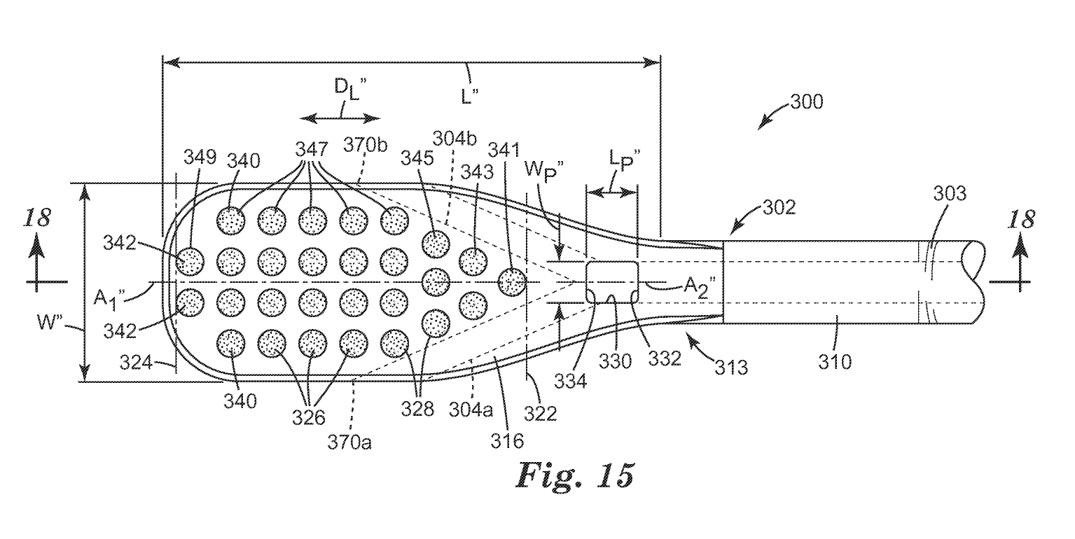

The suction oral brush 300 can include a handle 302 having a longitudinal direction D_{L}″ and a lumen 304 that extends along the longitudinal direction D_{L}″. The suction oral brush 300 can further include a proximal end (not shown) adapted to be coupled to a suction source (not shown) and a distal end 308 in fluid communication with the proximal end. In some embodiments, the handle 302 can include a shaft 310 and a brush head 312 coupled to a distal end of the shaft 310. In some embodiments, the distal end 308 of the suction oral brush 300 can also be the distal end 308 of the handle 302, and can include the head 312. In some embodiments, as shown in FIG. 15, the distal end 308 (or the head 312) can include a width W″ and a length L″ greater than the width W″.

As shown in FIGS. 13-16, the handle 302 can further include a bend 303 positioned along its length. The distal end 308 of the suction oral brush 300 (and particularly, the head 312) can include a first (top) side 316, a sidewall 317, and a second (bottom) side 318 opposite the first side 316. The suction oral brush 300 can further include bristles 320 (removed from FIG. 14 for clarity) positioned to extend outwardly (e.g., upwardly) of the first side 316 of the distal end 308 of the handle 302. As shown in FIGS. 15 and 18, the bristles 320 as a whole can include a proximal end 322 and a distal end 324. As further shown, the bristles 320 can be arranged into one or more bundles or tufts 326. Each tuft 326 of bristles 320 can be dimensioned to be received in a recess or aperture 328 formed in the first side 316 of the distal end 308 of the handle 302.

As shown in FIGS. 13-16 and 18, the suction oral brush 300 can further include an aperture 330 (sometimes referred to as a “proximal aperture”) formed through both the first side 316 and the second side 318 of the distal end 308 of the handle 302, or particularly, in the first side 316 of the head 312. Because the aperture 330 extends through both sides 316 and 318 of the head 312, the aperture 330 actually includes two suctioning sides, and therefore, in some embodiments, the aperture 330 can be referred to as two proximal apertures 330—a first proximal aperture 330 formed through the first side 316, and a second proximal aperture 330 formed through the second side 318, both being in fluid communication with the lumen 304. For simplicity, the aperture 330 that extends from the first side 316 through the second side 318 will be referred to herein as a singular aperture 330. However, it should be noted that the dual-sided aperture 330 of the embodiment shown in FIGS. 13-18 can have an advantage over the single-sided aperture 230 of FIGS. 7-12, in that having more than one suctioning side or surface can inhibit clogging of the aperture 330, tissue aspiration, or the like. Of course, the aperture 230 of FIGS. 7-12 can instead be configured to extend through the second side 218 of the suction oral brush 200, or the suction oral brush 200 can be configured to include an additional aperture (e.g., either a proximal or distal aperture, i.e., that is formed either in a side 216 or 218 or the sidewall 217).

As shown in FIG. 18, the aperture 330 can be positioned in fluid communication with the lumen 304 of the handle 302. As a result, the aperture 330 can be positioned to fluidly couple ambience to the lumen 304 (and to a suction source to which the suction oral brush 300 is coupled) and can be used as a suction hole. In the embodiment illustrated in FIGS. 13-18, the lumen 304 extends along the longitudinal direction D_{L}″ through the handle 302 and to the aperture 330, but does not extend further distally than the aperture 330. Furthermore, as described in greater detail below, the suction oral brush 300 does not include a distal aperture that interferes with any of the bristles 320, or more particularly, does not include a distal aperture that requires that any portion of the lumen 304 run underneath the bristles 320. Such a configuration can allow for a shorter (or thinner) head 312, similar to the head 212 of the suction oral brush 200 of FIGS. 7-12, described above.

As shown in FIGS. 14, 15 and 18, the aperture 330 can be positioned toward a proximal end 313 of the head 312, and the aperture 14, 15 and 18, the aperture 330 can be positioned entirely proximally of the bristles 320, such that the proximal end 332 of the aperture 330 can be positioned no further distally than the proximal end 322 of the bristles 320. In addition, the distal end 334 of the aperture 330 can be positioned no further distally than the proximal end 322 of the bristles 320. In the embodiment illustrated in FIGS. 13-18, the proximal end 332 and the distal end 334 of the aperture 330 are positioned proximally with respect to the proximal end 322 of the bristles 320. Such a configuration of the aperture 330 and relative positioning of the aperture 330 and the bristles 320 can provide for a suitable (e.g., reduced) width W″ of the head 312.

As shown in FIG. 15, the aperture 330 can include a width W_{P}″ and a length L_{P}″ that is greater than the width W_{P}″, such that the aperture 330 is elongated (e.g., rectangular, elliptical, oblong, etc.) and extends along the longitudinal direction D_{L}″. Furthermore, the aperture 330 can be positioned along a central longitudinal axis A₁″ of the suction oral brush 300 and the handle 302, such that a central longitudinal axis A₂″ of the aperture 330 is substantially in line with the central longitudinal axis A₁″, and such that the aperture 330 is centrally positioned with respect to the head 312, and particularly, with respect to the width W″ of the head 312 (and with respect to a width of the first side 316 of the distal end 308 of the handle 302). As shown in FIGS. 14 and 15, in some embodiments, two of the tufts 326 of bristles 320 (and the recesses 328 in which the tufts 326 are received) can be positioned along the central longitudinal axis A₁″ of the suction oral brush 300.

The range of values of the width W″ of the head 312 and the dimensions and relative dimensions of the aperture 330 can be the same as those of the head 112 and aperture 130, described above and shown in FIGS. 1-6.

The bristles 320, and particularly, the arrangement of the bristles 320 will now be described in greater detail with reference to FIG. 15. As shown in FIG. 15, in the embodiment illustrated in FIGS. 13-18, the suction oral brush 300 includes twenty-eight tufts 326 (and recesses 328 dimensioned to receive the tufts 326) of bristles 320 arranged in nine transverse rows oriented substantially perpendicularly with respect to the longitudinal direction D_{L}″. Moving distally along the head 312, as shown in FIG. 15, the nine transverse rows can be formed of: a first row 341 of a single tuft 326 falling along the central longitudinal axis A₁″ of the handle 302 and/or the central longitudinal axis A₂″ of the aperture 330; followed by a second row 343 of two tufts 326 centered about the central longitudinal axes A₁″ and A₂″; followed by a third row 345 of three tufts 326, the center tuft 326 of the third row 345 falling along the central longitudinal axes A₁″ and A₂″; followed by five fourth rows 347 of four tufts 326; followed by a final fifth row 349 of two tufts 326. Said another way, the bristles 320 can be arranged into three groups of tufts 326—a first group comprising three transverse rows 341, 343 and 345, the first row 341 having a single, centrally positioned tuft 326, the second row 343 having two tufts 326 and the third row 345 having three tufts 326, for a total of six tufts 326; a second group comprising five transverse rows 347, each row 347 comprising four tufts 326 for a total of twenty tufts 326; and a fourth group comprising one transverse row 349 of two tufts 326, for a final total of twenty-eight tufts 326.

As shown in FIGS. 13-15, each transverse row 341, 343, 345, 347, 349 can be centered with respect to the width W″ of the head 312, can be centered over the central longitudinal axis A₁″ of the handle 302 and/or the central longitudinal axis A₂″ of the aperture 330, and/or can be symmetrical about the central longitudinal axis A₁″ of the handle 302 and/or the central longitudinal axis A₂″ of the aperture 330. As further shown in FIG. 15, in some embodiments, the tufts 326 can be substantially uniformly spaced across the width W″ and the length L″ of the head 312. Furthermore, only the center two tufts 326 of the first transverse row 341 and third transverse row 345 fall on the centerline of the head 312, i.e., along the central longitudinal axis A₁″ of the handle 302 and/or the central longitudinal axis A₂″ of the aperture 330.

In addition, the width W″ of the head 312 can vary along its length L″, such that each transverse row 341, 343, 345, 347, 349 includes one or more tufts 326 that are positioned adjacent an outer edge or wall (e.g., the sidewall 317) of the head 312. As a result of the above configurations, in some embodiments, the suction oral brush 300 can include twenty-eight tufts 326 of bristles 320, and the density of the bristles 320 (or the tufts 326) can be maximized on the first side 316 of the head 312. Similar to the suction oral brush 100, at the widest portion of the head 312, the suction oral brush 300 includes four longitudinal rows—two outer longitudinal rows 340 and two inner longitudinal rows 342. However, it should be understood that other numbers of longitudinal rows 340, 342 (e.g., six) are possible.

Furthermore, as shown in FIGS. 13-15, the first transverse row 341 can be positioned adjacent the width W_{P}″ of the aperture 330, such that the proximal end 322 of the bristles 320 is positioned adjacent the width W_{P}″ and the distal end 334 of the aperture 330. In addition, in some embodiments, the width W_{P}″ of the aperture 330 can be less than an overall width of the second or fifth transverse row 343 or 349 (or of two tufts 326), where the “overall width” of the second or fifth transverse row 343 or 349 (or of two tufts 326) includes the width (or diameter) of two tufts 326 and the spacing between the two tufts 326.

The relative positioning and arrangement between the bristles 320 and the aperture 330 described above can allow the head 312 (or the distal end 308 of the handle 302) to have a suitable (e.g., reduced) width W″, e.g., to facilitate accessing an oral cavity, and can allow the bristles 320 a relatively dense configuration, e.g., to facilitate cleaning a patient's teeth and gums.

With reference to FIG. 17, in some embodiments, the bristles 320 can be formed to a substantially uniform height H_{B}″, the head 312 can have a substantially uniform height H″ (i.e., the first side 316 can be substantially flat), and distal end 308 of the suction oral brush 300 can have a total height H_{T}″, which can include the bristle height H_{B}″ and the head height H″, as well as the height of a cleaning pad, if employed, as described below. The range of values of the bristle height H_{B}″, the head height H″, the total height H_{T}″, and the relative values and ratios thereof, can be same as those of the bristle height H_{B}′, head height H′, and total height H_{T}′ described above and shown in FIGS. 7-12.

As shown in FIGS. 17 and 18 and mentioned above, in some embodiments, the suction oral brush 300 does not include a distal aperture that extends through the distal tip 352 of the head 312, and the suction oral brush 300 therefore need not include a portion that runs underneath the bristles 320, such that a distal tip 352 of the head 312 is closed and is not in fluid communication with the lumen 304 or a suction source. Not including a distal aperture in the suction oral brush 300 can allow the head height H″ and the total height H_{T}″ to be substantially reduced.

As shown in FIGS. 13-15 and 18, in some embodiments, the suction oral brush 300 can further include one or more apertures 370 (which can be referred to as “distal apertures” or “sidewall apertures” or “side apertures”) formed in the sidewall 317 of the distal end 308 of the handle 302, and positioned in fluid communication with the lumen 304. As shown in FIGS. 13-15, when more than one aperture 370 is employed, such as the two apertures 370 that are shown in FIG. 15, the lumen 304 can actually include a portion where it divides (e.g., bifurcates) to extend to the multiple apertures 370. By way of example only, as shown in FIGS. 13-15 and 18, in some embodiments, the lumen 304 can include a first portion 304a that extends to a first aperture 370a and a second portion 304b that extends to a second aperture 370b. The side apertures 370 can provide access to the lumen 304, such that the side apertures 370 fluidly couple ambience to the lumen 304 (and to a suction source to which the suction oral brush 300 is coupled), and can be used for suctioning.

The apertures 370 are shown by way of example only as being formed in a left and right sidewall 317 of the head 312 (or the distal end 308 of the handle 302). That is, the apertures 370 are positioned on the sides of the suction oral brush 300, and as a result, the lumen 304 does not need to extend through the distal tip 352 of the head 312. Rather, by positioning the side apertures 370 further proximally on the head 312 (than if they were formed in the distal tip 352), the lumen 304 need not include any portion that runs underneath the bristles 320. As a result, the apertures 370 can be referred to as “side apertures.” Still, because the apertures 370 are formed in the sidewall 317 and positioned distally with respect to the proximal aperture 330, the apertures 370 can also be referred to as “distal apertures.”

For simplicity and clarity, one side aperture or distal aperture 370 will be described in greater detail. As shown in FIG. 13, the side aperture 370 can include a length L_{D}″ and a height H_{D}″, and the length L_{D}″ can be greater than the height H_{D}″. The side aperture 370 is described by way of example only as having a “length” and a “height” to be consistent with the orientations of the suction oral brush 300; however, it should be understood that the side aperture 370 can instead be described in the same way as the distal aperture 150 of the suction oral brush 100, that is, as having a width W_{D}″ (instead of a “length”). Whether the side aperture 370 is described as having a length or a width, it should be understood that any of the above descriptions of the distal aperture 150 and its dimensions and relationships of dimensions can equally be applied to the side apertures 370 of the suction oral brush 300.

That is, as shown, the distal aperture 370 can be elongated (e.g., rectangular, elliptical, oblong, etc.). Unlike the distal aperture 150 of FIGS. 1-6, however, the distal aperture 370 of FIGS. 13-18 is oriented in a direction substantially parallel to the longitudinal direction D_{L}. Said another way, the distal aperture 370 can be elongated along the length L″ of the head 312. Such a configuration of the distal aperture 370 can allow the head 312 (or the distal end 308 of the handle 302) to have a suitable (e.g., reduced) height, which can facilitate accessing and navigating an oral cavity. Said another way, both the distal aperture 150 of FIGS. 1-6 and the side apertures 370 of FIGS. 13-18 are elongated in a direction parallel to the sidewall 117 and 317, respectively, and include a dimension in the direction of the sidewall 117, 317 that is greater than its height H_{D}, H_{D}″.

As mentioned above, the side apertures 370 are positioned such that no portion of the lumen 304 needs to extends adjacent an end of the bristles 320 (i.e., underneath the bristles 320). Rather, the divided portions 304a and 304b of the lumen 304 run adjacent a side of some of the bristles 320 to extend to the sidewall 317. As such, the height H″ of the head 312 (or of the distal end 308 of the handle 302) can be substantially reduced.

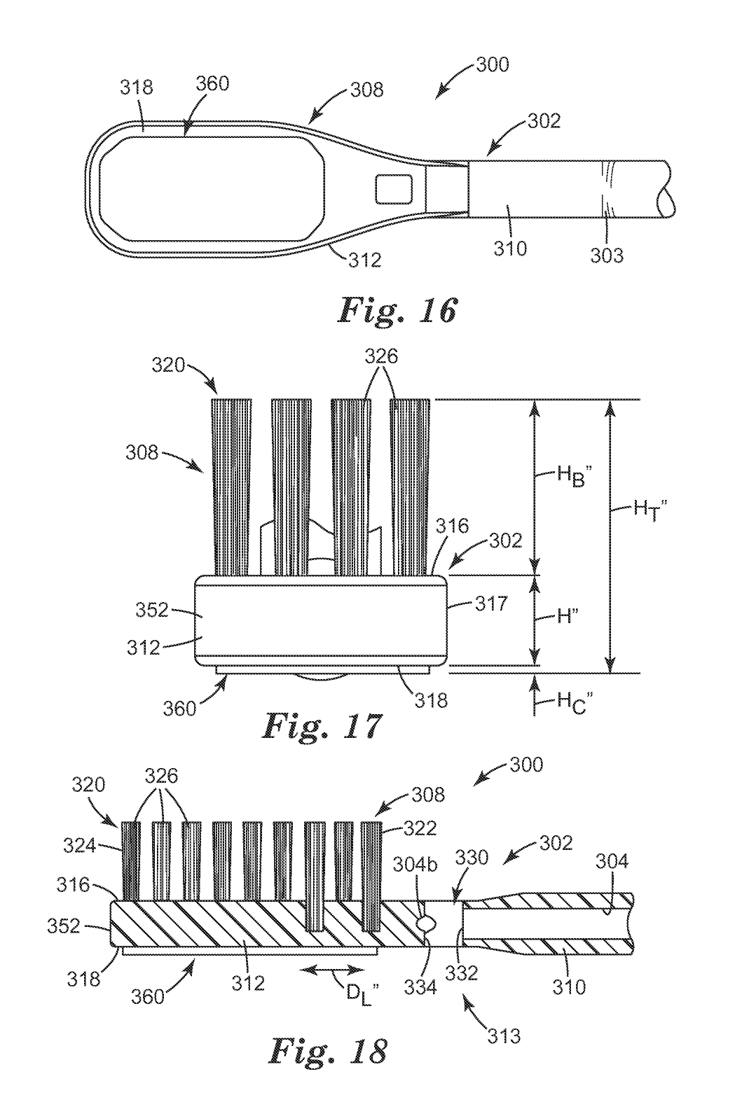

As shown in FIGS. 16-18, in some embodiments, the suction oral brush 300 can further include a cleaning pad 360. In some embodiments, as shown in FIGS. 16-18, the cleaning pad 360 can be coupled to the second side 318 of the head 312. The cleaning pad 360 can be formed of the same materials as the cleaning pad 160 of FIGS. 1-6 and can include one or more projections configured to facilitate cleaning of the tongue or other tissues.

As shown in FIG. 17, the cleaning pad 360 can include a height H_{C}″, which can be included in the total height H_{T}″ of the distal end 308 of the suction oral brush 300. In addition, the values of the cleaning pad height H_{C}″ and its relationships to the head height H″ and the total height H_{T}″ can be the same as the cleaning pad height H_{C}, the head height H, and the total height H_{T} of FIGS. 1-6, described above.

As can be understood by the three illustrated embodiments of FIGS. 1-6, 7-12 and 13-18 and the above disclosure, the suction oral brush 100 can be employed to achieve a suitable (e.g., reduced) width W of the head 112, for example, by ensuring that no bristles 120 fall along the center longitudinal axes A₁ or A₂. In addition, the suction oral brush 100 can be employed to achieve a suitable height H of the head 112, for example, by employing a distal aperture 150 that is elongated along the sidewall 117, and is wider than it is tall (i.e., has a width W_{D} greater than its height H_{D}). The suction oral brushes 200 and 300 (which do not include any portion of the lumen 204, 304 that extends underneath the bristles 220, 320), can especially be employed to achieve a suitable (e.g., reduced) height H′, H″ of the head 212, 312. As a result, an even thinner head 212, 312 may be achieved in the suction oral brushes 200 and 300 than in the suction oral brush 100.

In addition, at least partly because the suction oral brush 100 does not include any bristles 120 on its center longitudinal axes A₁ and A₂, the suction oral brush 100 may achieve and even narrower head 112 (e.g., with respect to the width W) than in the suction oral brushes 200 and 300. However, all three of the illustrated oral brushes 100, 200, 300 include a suitable (e.g., reduced) width at least partially due to locating the aperture 130, 230, 330 on the head 112, 212, 312 such that the proximal end 132, 232, 332 of the aperture 130, 230, 300 is positioned no further distally than the proximal end 122, 22, 322 of the bristles 120, 220, 320. Such positioning eliminates the mechanical spacing (i.e., tolerance) needed between the sides of the aperture 130, 230, 330 and the bristles 120, 220, 320, such that the overall width W, W′, W″ of the head 112, 212, 312 can be reduced. The bristle arrangements shown in the suction oral brushes 200 and 300 are shown by way of example only, and it should be understood that other bristle arrangements are possible, similar to the arrangement shown in the suction oral brush 100, that would allow for an even further reduction in the width W′, W″ of the head 212, 312.

Furthermore, each of the suction oral brushes 100, 200, 300 include proximal apertures 130, 230, 330 and distal apertures 150 and 370 that are formed on the respective head 112, 212, 312, rather than the shaft 102, 202, 302, such that all of the brushing, suctioning and/or venting can be performed by one portion of the suction oral brush 100, 200, 300, which can allow for suctioning of debris as it is removed from the teeth and oral tissues.

While the suction oral brushes 100, 200 and 300 are illustrated as being three distinct embodiments, it should be understood that a suction oral brush of the present disclosure can include any combination of the features and elements taught by the three illustrated embodiments.

### Embodiments

Embodiment 1 is a suction oral brush comprising:
a handle, the handle having a longitudinal direction and a lumen, the handle including a proximal end and a distal end in fluid communication with the proximal end, the proximal end adapted to be coupled to a suction source;
a plurality of bristles extending outwardly of a first side of the distal end of the handle, the plurality of bristles including a proximal end and a distal end; and
an aperture formed in the first side of the distal end of the handle, the aperture being in fluid communication with the lumen of the handle, the aperture having a proximal end and a distal end, the proximal end of the aperture being positioned no further distally than the proximal end of the plurality of bristles.

Embodiment 2 is a suction oral brush comprising:
a handle, the handle having a longitudinal direction and a lumen, the handle including a proximal end and a distal end in fluid communication with the proximal end, the proximal end adapted to be coupled to a suction source, the distal end including a first side and a sidewall;
a plurality of bristles extending outwardly of the first side of the distal end of the handle; and
a distal aperture formed in the sidewall of the distal end of the handle, the distal aperture being in fluid communication with the lumen of the handle, the distal aperture having a width and a height, wherein the width is greater than the height.

Embodiment 3 is a suction oral brush comprising:
a handle, the handle having a longitudinal direction and a lumen, the handle including a proximal end and a distal end in fluid communication with the proximal end, the proximal end adapted to be coupled to a suction source; and
a plurality of bristles extending outwardly of a first side of the distal end of the handle, the plurality of bristles arranged such that none of the bristles are positioned along a central longitudinal axis of the distal end of the handle.

Embodiment 4 is the suction oral brush of any of embodiments 1-3, wherein the handle includes a shaft and a head coupled to the shaft, wherein the distal end of the handle includes the head, wherein the plurality of bristles extend outwardly of a first side of the head.

Embodiment 5 is the suction oral brush of embodiment 4, wherein the aperture is formed in the first side of the head.

Embodiment 6 is the suction oral brush of embodiment 4, wherein the shaft includes a substantially circular cross-sectional shape, and wherein the head includes a substantially rectangular or oblong cross-sectional shape.

Embodiment 7 is the suction oral brush of any of embodiments 1 and 4-6, wherein the aperture is elongated along the longitudinal direction of the handle.

Embodiment 8 is the suction oral brush of any of embodiments 1 and 4-7, wherein the aperture is positioned to fluidly couple ambience to the lumen of the handle.

Embodiment 9 is the suction oral brush of any of embodiments 1 and 4-8, wherein the aperture includes a width and a length greater than the width, and wherein the length extends along the longitudinal direction of the handle.

Embodiment 10 is the suction oral brush of any of embodiments 1 and 4-9, wherein the aperture is centrally positioned with respect to a width of the first side of the distal end of the handle.

Embodiment 11 is the suction oral brush of any of embodiments 1 and 4-10, wherein the aperture extends along a central longitudinal axis of the distal end of the handle, and wherein none of the plurality of bristles is positioned along the central longitudinal axis.

Embodiment 12 is the suction oral brush of any of embodiments 1 and 4-11, wherein the aperture extends along a central longitudinal axis of the distal end of the handle, and wherein two of the plurality of bristles are positioned along the central longitudinal axis.

Embodiment 13 is the suction oral brush of any of embodiments 1 and 3-12, wherein the distal end of the handle includes a sidewall, and further comprising a distal aperture formed in the sidewall of the distal end of the handle, the distal aperture being in fluid communication with the lumen of the handle, the distal aperture having a width and a height, and wherein the width is greater than the height.

Embodiment 14 is the suction oral brush of embodiment 13, wherein the aperture includes a width, and wherein the width of the aperture is as wide as the width of the distal aperture.

Embodiment 15 is the suction oral brush of any of embodiments 2 and 13-14, wherein the distal aperture is oriented substantially orthogonally with respect to the longitudinal direction of the handle.

Embodiment 16 is the suction oral brush of any of embodiments 1-15, wherein the plurality of bristles is arranged in no more than six rows that extend along the longitudinal direction of the handle.

Embodiment 17 is the suction oral brush of embodiment 16, wherein the rows are arranged symmetrically about a central longitudinal axis of the distal end of the handle.

Embodiment 18 is the suction oral brush of any of embodiments 1 and 4-17, wherein the plurality of bristles is arranged in a plurality of rows that extend generally along the longitudinal direction of the handle, and wherein a width of the aperture is less than an overall width of two rows of bristles.

Embodiment 19 is the suction oral brush of any of embodiments 1-18, wherein the plurality of bristles is arranged in a plurality of rows that extend generally along the longitudinal direction of the handle, and wherein some of the plurality of rows extend further proximally with respect to the handle than others of the plurality of rows.

Embodiment 20 is the suction oral brush of any of embodiments 1-19, wherein the plurality of bristles is arranged in a plurality of inner rows and outer rows that extend generally along the longitudinal direction of the handle, and wherein the outer rows are longer than the inner rows.

Embodiment 21 is the suction oral brush of embodiment 20, wherein the outer rows include a proximal end, and wherein the proximal end of the aperture is positioned no further distally than the proximal end of the outer rows.

Embodiment 22 is the suction oral brush of embodiment 20 or 21, wherein the inner rows include a proximal end that is positioned distally of the distal end of the aperture.

Embodiment 23 is the suction oral brush of any of embodiments 20-22, wherein the aperture includes a width and a length, wherein the inner rows are positioned adjacent the width of the aperture, and wherein the outer rows include a portion that is positioned adjacent the length of the aperture.

Embodiment 24 is the suction oral brush of any of embodiments 20-23, wherein the inner rows are positioned distally with respect to the aperture.

Embodiment 25 is the suction oral brush of any of embodiments 1-24, wherein the plurality of bristles is arranged in a plurality of tufts.

Embodiment 26 is the suction oral brush of embodiment 25, wherein the plurality of tufts includes twenty-eight tufts.

Embodiment 27 is the suction oral brush of embodiment 25, wherein the plurality of tufts includes thirty tufts.

Embodiment 28 is the suction oral brush of any of embodiments 25-27, wherein the plurality of tufts includes two rows of eight tufts and two rows of six tufts.

Embodiment 29 is the suction oral brush of any of embodiments 25-28, wherein the plurality of tufts is arranged in a plurality of transverse rows, and wherein each transverse row of tufts is arranged symmetrically about a central longitudinal axis of the distal end of the handle.

Embodiment 30 is the suction oral brush of any of embodiments 1, 2 and 4-29, wherein none of the plurality of bristles is positioned on a longitudinal centerline of the distal end of the handle.

Embodiment 31 is the suction oral brush of any of embodiments 1-30, wherein the plurality of bristles is arranged in a plurality of transverse rows that extend substantially perpendicularly with respect to the longitudinal direction of the handle.

Embodiment 32 is the suction oral brush of embodiment 31, wherein the plurality of transverse rows includes nine transverse rows.

Embodiment 33 is the suction oral brush of any of embodiments 1-32, wherein the plurality of bristles is formed of nylon.

Embodiment 34 is the suction oral brush of any of embodiments 1-33, wherein the plurality of bristles includes a substantially uniform height.

Embodiment 35 is the suction oral brush of any of embodiments 1-34, wherein the distal end of the handle includes a head, and wherein the plurality of bristles extends outwardly from a first side of the head, and wherein the head includes a substantially uniform height.

Embodiment 36 is the suction oral brush of any of embodiments 1 and 4-35, wherein the distal end of the handle includes a head, and wherein the plurality of bristles extends outwardly from a first side of the head, wherein the aperture includes a width and a length, and wherein the ratio of the width of the aperture to the width of the head is at least about 0.3.

Embodiment 37 is the suction oral brush of any of embodiments 1-36, wherein the distal end of the handle includes a head from which the plurality of bristles extends, and wherein the height of the head is no greater than 0.8 cm.

Embodiment 38 is the suction oral brush of any of embodiments 1-37, wherein the distal end of the handle includes a total height, wherein the plurality of bristles includes a height, and wherein the ratio of bristle height to total height is at least about 0.35.

Embodiment 39 is the suction oral brush of any of embodiments 1-38, wherein the distal end of the handle includes a head from which the plurality of bristles extends, and wherein the width of the head is no greater than 1.3 cm.

Embodiment 40 is the suction oral brush of any of embodiments 1-39, wherein the plurality of bristles includes a height of at least about 0.8 cm.

Embodiment 41 is the suction oral brush of any of embodiments 1-40, wherein the distal end of the handle includes a head from which the plurality of bristles extends, and wherein the total height of the head and the bristles is no greater than about 1.7 cm.

Embodiment 42 is the suction oral brush of any of embodiments 1-41, wherein the distal end of the handle includes a second side opposite the first side, and further comprising a cleaning pad coupled to the second side of the distal end of the handle.

Embodiment 43 is the suction oral brush of embodiment 42, wherein the distal end of the handle includes a head from which the plurality of bristles extends, wherein the head includes a height, wherein the cleaning pad includes a height, and wherein the ratio of cleaning pad height to head height is no greater than 0.35.

The following working and prophetic examples are intended to be illustrative of the present disclosure and not limiting.

### Examples

Working example 1 and prophetic examples 2-3 represent three exemplary suction oral brushes according to the present disclosure. Example 1 was configured as shown in FIGS. 1-6, Example 2 was configured as shown in FIGS. 7-12, and Example 3 was configured as shown in FIGS. 13-18. Comparative Example A was an existing Sage suction oral brush (e.g., the “suction toothbrush” found in Suction Toothbrush Kit w/Perox-a-mint Solution—product no. 6671, available from Sage Products, Inc., Crystal Lake, Ill.). Comparative Example B was an existing Medline suction oral brush (e.g., the “suction toothbrush” found in the Suction Toothbrush Economy Kit—product no. MDS096571, available from Medline Industries, Inc., Mundelein, Ill.). Comparative Example C was an existing Kimberly Clark suction oral brush (e.g., the “suction toothbrush” found in Kimberly Clark Oral Care Systems kits, such as Product No. 12509, available from Kimberly-Clark Corporation, Irving, Tex.).

Measurements of various features of the suction oral brushes of Example 1 and Comparative Examples A-C were taken with a calipers. Measurements for Examples 2-3 were obtained from modeling software. The results of these comparative measurements are shown in Table 1. The values reported in Table 1 are approximate values, and measurements of bristles can be ±10% of the value reported, and measurements of the head and cleaning pad can be ±5% of the value reported. In Table 1, all dimensions and areas are shown in inches and square inches, respectively. In addition, all dimensions and areas are shown in centimeters and square centimeters, respectively, underneath the value in inches or square inches.

TABLE 1
Suction oral brush dimensions and comparisons.

| Ex. | 1 | 2 | 3 | A | B | C |
|---|---|---|---|---|---|---|
| Head height | 0.260 | 0.180 | 0.180 | 0.330 | 0.300 | 0.250 |
| (H) | 0.660 | 0.457 | 0.457 | 0.838 | 0.762 | 0.635 |
| Head width | 0.450 | 0.420 | 0.480 | 0.560 | 0.520 | 0.350 |
| (W) | 1.14 | 1.07 | 1.22 | 1.42 | 1.32 | 0.889 |
| # of Bristle Tufts | 28 | 30 | 28 | 29 | 28 | N/A* |
| Min. Bristle | 0.350 | 0.350 | 0.350 | 0.220 | 0.350 | 0.375 |
| Height (H_{B}) | 0.889 | 0.889 | 0.889 | 0.559 | 0.889 | 0.953 |
| Cleaning Pad | 0.030 | 0.030 | 0.030 | 0.200 | 0.175 | N/A |
| Height (H_{C}) | 0.076 | 0.076 | 0.076 | 0.508 | 0.445 | |
| Total Height | 0.640 | 0.560 | 0.560 | 0.750 | 0.825 | 0.625 |
| (H_{T}) | 1.63 | 1.42 | 1.42 | 1.91 | 2.10 | 1.59 |
| Distal | 0.200 | N/A | 0.210 | N/A | N/A | N/A |
| Aperture | 0.508 | | 0.533 | | | |
| Width (W_{D}) | | | | | | |
| Distal | 0.075 | N/A | 0.090 | N/A | N/A | N/A |
| Aperture | 0.191 | | 0.229 | | | |
| Height (H_{D}) | | | | | | |
| Distal | N/A | N/A | N/A | 0.125 | 0.100 | 0.150 |
| Aperture | | | | 0.318 | 0.254 | 0.381 |
| Diameter | | | | | | |
| Total Distal | 0.015 | N/A | 0.030 | 0.012 | 0.008 | 0.018 |
| Aperture | 0.097 | | 0.194 | 0.077 | 0.052 | 0.116 |
| Cross- | | | | | | |
| sectional Area | | | | | | |
| W_{D}/W | 0.44 | N/A | 0.5 | 0.23 | 0.19 | 0.43 |
| H_{B}/H_{T} | 0.55 | 0.63 | 0.63 | 0.29 | 0.42 | 0.60 |

*This toothbrush did not include bristles like the others - the bristles are molded (of polyethylene) with the head, and they are not arranged in tufts that can easily be counted.

The embodiments described above and illustrated in the figures are presented by way of example only and are not intended as a limitation upon the concepts and principles of the present disclosure. As such, it will be appreciated by one having ordinary skill in the art that various changes in the elements and their configuration and arrangement are possible without departing from the spirit and scope of the present disclosure. Various features and aspects of the present disclosure are set forth in the following claims.

What is claimed is:

1. A suction oral brush comprising:
a handle, the handle having a longitudinal direction and a lumen, the handle including a proximal end and a distal end in fluid communication with the proximal end, the proximal end adapted to be coupled to a suction source;
a plurality of bristles extending outwardly of a first side of the distal end of the handle, the plurality of bristles including a proximal end and a distal end; and
an aperture formed in the first side of the distal end of the handle, the aperture being in fluid communication with the lumen of the handle, the aperture having a proximal end and a distal end, the proximal end of the aperture being positioned no further distally than the proximal end of the plurality of bristles.

2. The suction oral brush of claim 1, wherein the handle includes a shaft and a head coupled to the shaft, wherein the distal end of the handle includes the head, wherein the plurality of bristles extend outwardly of a first side of the head.

3. The suction oral brush of claim 2, wherein the aperture is formed in the first side of the head.

4. The suction oral brush of claim 2, wherein the shaft includes a substantially circular cross-sectional shape, and wherein the head includes a substantially rectangular or oblong cross-sectional shape.

5. The suction oral brush of claim 1, wherein the aperture is elongated along the longitudinal direction of the handle.

6. The suction oral brush of claim 1, wherein the aperture includes a width and a length greater than the width, and wherein the length extends along the longitudinal direction of the handle.

7. The suction oral brush of claim 1, wherein the aperture is centrally positioned with respect to a width of the first side of the distal end of the handle.

8. The suction oral brush of claim 1, wherein the aperture extends along a central longitudinal axis of the distal end of the handle, and wherein none of the plurality of bristles is positioned along the central longitudinal axis.

9. The suction oral brush of claim 1, wherein the aperture extends along a central longitudinal axis of the distal end of the handle, and wherein two of the plurality of bristles are positioned along the central longitudinal axis.

10. The suction oral brush of claim 1, wherein the distal end of the handle includes a sidewall, and further comprising a distal aperture formed in the sidewall of the distal end of the handle, the distal aperture being in fluid communication with the lumen of the handle, the distal aperture having a width and a height, and wherein the width is greater than the height.

11. The suction oral brush of claim 10, wherein the distal aperture is oriented substantially orthogonally with respect to the longitudinal direction of the handle.

12. The suction oral brush of claim 1, wherein the plurality of bristles is arranged in a plurality of inner rows and outer rows that extend generally along the longitudinal direction of the handle, and wherein the outer rows are longer than the inner TOWS.

13. The suction oral brush of claim 12, wherein the outer rows include a proximal end, and wherein the proximal end of the aperture is positioned no further distally than the proximal end of the outer rows.

14. The suction oral brush of claim 12, wherein the inner rows include a proximal end that is positioned distally of the distal end of the aperture.

15. The suction oral brush of claim 12, wherein the aperture includes a width and a length, wherein the inner rows are positioned adjacent the width of the aperture, and wherein the outer rows include a portion that is positioned adjacent the length of the aperture.

16. The suction oral brush of claim 1, wherein the plurality of bristles is formed of nylon.

17. The suction oral brush of claim 1, wherein the distal end of the handle includes a head, and wherein the plurality of bristles extends outwardly from a first side of the head, wherein the aperture includes a width and a length, and wherein the ratio of the width of the aperture to the width of the head is at least about 0.3.

18. The suction oral brush of claim 1, wherein the distal end of the handle includes a head from which the plurality of bristles extends, and wherein the height of the head is no greater than 0.8 cm.

19. The suction oral brush of claim 1, wherein the distal end of the handle includes a head from which the plurality of bristles extends, and wherein the total height of the head and the bristles is no greater than about 1.7 cm.

20. A suction oral brush comprising:
a handle, the handle having a longitudinal direction and a lumen, the handle including a proximal end and a distal end in fluid communication with the proximal end, the proximal end adapted to be coupled to a suction source, the distal end including a first side and a sidewall;
a plurality of bristles extending outwardly of the first side of the distal end of the handle; and
a distal aperture formed in the sidewall of the distal end of the handle, the distal aperture being in fluid communication with the lumen of the handle, the distal aperture having a width and a height, wherein the width is greater than the height.

21. A suction oral brush comprising:
a handle, the handle having a longitudinal direction and a lumen, the handle including a proximal end and a distal end in fluid communication with the proximal end, the proximal end adapted to be coupled to a suction source; and
a plurality of bristles extending outwardly of a first side of the distal end of the handle, the plurality of bristles arranged such that none of the bristles are positioned along a central longitudinal axis of the distal end of the handle.
